(19) United States
(12) Patent Application Publication
(10) Pub. No.: US 2021/0260482 A1
(43) Pub. Date: Aug. 26, 2021

(54) INFORMATION PROCESSING DEVICE AND INFORMATION PROCESSING METHOD

(71) Applicant: Sony Corporation, Tokyo (JP)

(72) Inventor: Ryo Nakahashi, Tokyo (JP)

(73) Assignee: Sony Corporation, Tokyo (JP)

(21) Appl. No.: 17/254,920

(22) PCT Filed: Mar. 28, 2019
(86) PCT No.: PCT/JP2019/013846

§ 371 Date: Dec. 22, 2020

(30) Foreign Application Priority Data
Jun. 29, 2018 (JP) 2018-124453

(51) Int. Cl. A63F 13/5375; G06N 20/00

(52) U.S. Cl. CPC A63F 13/5375; A63F 13/803; G06N 20/00

(57) ABSTRACT

An information processing device (10) includes an extraction unit (18C) and an output control unit (18D). The extraction unit (18C) extracts a specific situation of a content whose situation changes according to an action of a user based on an action model of the user. The output control unit (18D) outputs advice information regarding the specific situation.

### FIELD

The present disclosure relates to an information processing device and an information processing method.

### BACKGROUND

In computer games and sports performed in a real space, a feeling of success or a feeling of achievement when a user acquires skills is one of real pleasures. However, there is a case where time is required to acquire a highly difficult skill. Therefore, there is known a training application in which a skill is acquired step by step (for example, Non Patent Literature 1).

### CITATION LIST

### Non Patent Literature

Non Patent Literature 1: David Silver 1 and others, “Mastering the game of Go with deep neural networks and tree search”, ARTICLE, doi:10.1038/nature16961

### SUMMARY

### Technical Problem

However, the training application is uniform, so that it is difficult to provide advice information according to an action of a user.

Therefore, the present disclosure proposes an information processing device and an information processing method capable of providing advice information according to an action of a user.

### Solution to Problem

To solve the problem described above, an information processing device includes: an extraction unit that extracts a specific situation of a content whose situations change according to an action of a user based on an action model of the user; and an output control unit that outputs advice information regarding the specific situation.

### Advantageous Effects of Invention

According to the present disclosure, it is possible to provide the advice information according to the action of the user. Note that the effects described here are not necessarily limited, and may be any of the effects described in the present disclosure.

### BRIEF DESCRIPTION OF DRAWINGS

FIG. 1 is a schematic diagram illustrating an example of an information processing system according to a first embodiment of the present disclosure, a modification of the first embodiment, or a second embodiment.

FIG. 2 is a schematic view illustrating examples of a content according to the first embodiment of the present disclosure.

FIG. 3 is a diagram illustrating an example of a functional block diagram of an information processing device and a terminal device according to the first embodiment or the second embodiment of the present disclosure.

FIG. 4 is a schematic view illustrating examples of data configurations of first action history information and second action history information according to the first embodiment of the present disclosure.

FIG. 5 is an explanatory view illustrating an example of extraction of an occurrence factor according to the first embodiment of the present disclosure.

FIG. 6 is a schematic view illustrating an example of a display screen according to the first embodiment of the present disclosure.

FIG. 7 is a flowchart illustrating an example of an information processing procedure according to the first embodiment of the present disclosure.

FIG. 8 is a flowchart illustrating an example of an output processing procedure according to the first embodiment of the present disclosure.

FIG. 9 is a diagram illustrating an example of a functional block diagram of an information processing device and the terminal device according to the modification of the first embodiment of the present disclosure.

FIG. 10 is an explanatory view illustrating an example of generation of third action history information according to the modification of the first embodiment of the present disclosure.

FIG. 11 is a flowchart illustrating an example of an information processing procedure according to the modification of the first embodiment of the present disclosure.

FIG. 12 is a schematic view illustrating an example of a display screen according to the second embodiment of the present disclosure.

FIG. 13 is a flowchart illustrating an example of an information processing procedure according to the second embodiment of the present disclosure.

FIG. 14 is a hardware configuration diagram illustrating an example of a computer that implements functions of the information processing device and the terminal device of the present disclosure.

### DESCRIPTION OF EMBODIMENTS

Hereinafter, embodiments of the present disclosure will be described in detail with reference to the drawings. Note that the same portions are denoted by the same reference signs in each of the following embodiments, and a repetitive description thereof will be omitted.

### First Embodiment

### Configuration of Information Processing System According to First Embodiment

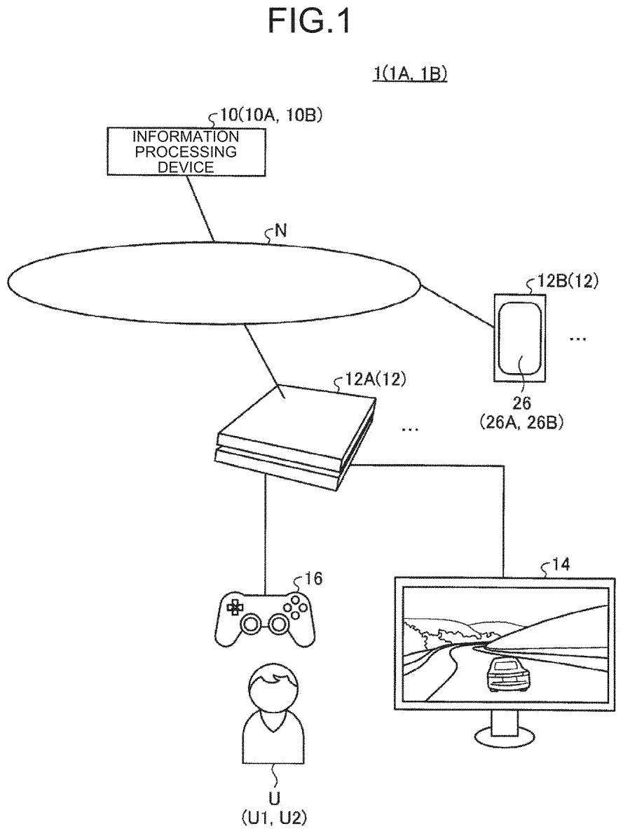

FIG. 1 is a schematic diagram illustrating an example of an information processing system 1 of the present embodiment.

The information processing system 1 includes an information processing device 10 and a terminal device 12. The information processing device 10 and the terminal device 12 are connected via a network N to be capable of communicating with each other. It suffices that the information processing device 10 and the terminal device 12 are connected to be capable of communicating with each other in a wireless or wired manner, and a communication form is not limited.

The information processing device 10 is a device that provides advice information according to an action of a user U with respect to a content.

The content is an event whose situation changes according to the action of the user U. In other words, the content is an application program that outputs a changed situation as the situation in the content changes according to the input action of the user U. Specifically, the content is represented by a set of changes in the situation for the action of the user U. For example, when an action signal indicating the action of the user U is input to the content, the content outputs situation information indicating a changed situation according to the action signal. Note that, in the following description, an action signal will be simply referred to as an action, and situation information will be simply referred to as a situation in some cases.

Specifically, the content is a game executed on a computer. The game indicates a simulation game or a computer game that virtually plays a real-life event or experience.

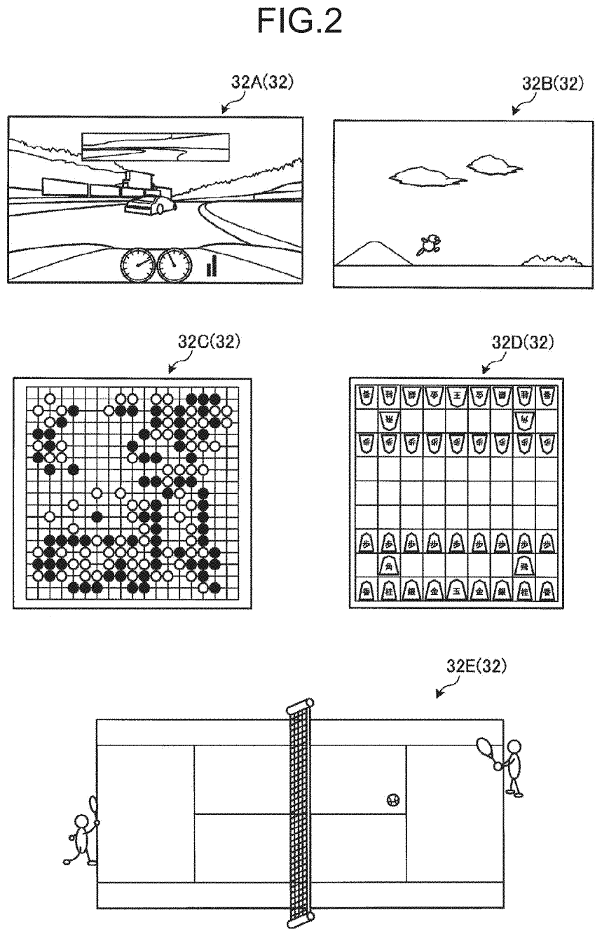

FIG. 2 is a schematic view illustrating an example of a content 32. Examples of the content 32 include a drive game 32A, an action game 32B, a board game 32C, a board game 32D, a sports game 32E, and the like. The drive game 32A is a game in which a vehicle is driven in a virtual space. The action game 32B is a game in which a situation in the game changes according to the movement of a character. The board game 32C is a Go board game. The board game 32D is a Japanese chess board game. The sports game 32E is a game representing sports such as a match and a competition.

Note that a type of the content 32 is not limited to these examples. For example, the content 32 may be an application program for simulation that virtually executes a real-life event or experience, such as sports and driving of a vehicle, conducted in the real life. Further, the content 32 may be an application program that simply executes a part of an event conducted in the real life. That is, the content 32 may be one that provides an event, such as a sport, conducted by the user U in a real space as a program simulating at least a part of the event.

Returning to FIG. 1, the description will be continued. The information processing device 10 of the present embodiment outputs advice information according to the action of the user U with respect to the content 32. Details of the action of the user U and the advice information will be described later. In the present embodiment, the information processing device 10 outputs the advice information by transmitting the advice information to the terminal device 12. Details of the information processing device 10 will be described later.

The terminal device 12 is a device that outputs the advice information received from the information processing device 10. A program (hereinafter, referred to as a game program), configured to implement the content 32, is installed in the terminal device 12 in advance. The terminal device 12 outputs the advice information at a predetermined timing such as during the execution of the content 32 or before the execution of the content 32.

The terminal device 12 is preferably a device that can output the advice information received from the information processing device 10 in a form that enables confirmation of the user U. Further, the terminal device 12 is preferably a device capable of executing the content 32 and a device capable of outputting the advice information from the viewpoint of outputting the advice information during the execution of the content 32 or before the execution of the content 32. In FIG. 1, a game device 12A and a mobile terminal 12B are illustrated as examples of the terminal device 12.

The game device 12A is a device that executes a game which is an example of the content 32. The game device 12A has, for example, a read only memory (ROM) drive, and operates as the game device 12A by inserting a game ROM into the ROM drive and executing a game program. Note that the game device 12A can also operate as an emulation device that executes an image file of the game program by starting an emulator program. Note that the emulator program may be acquired via the network N or may be pre-installed at the time of shipment.

An output unit 14 and an input unit 16 are connected to the game device 12A in a wired or wireless manner. The input unit 16 is an input interface device configured to allow the user U to perform an operation input with respect to the game device 12A. The input unit 16 outputs an operation signal according to an operation instruction of the user U to the game device 12A. The input unit 16 is a controller, a keyboard, a touch panel, a pointing device, a mouse, an input button, or the like.

The output unit 14 is a display that displays various images. The output unit 14 is, for example, a known liquid crystal display (LCD) or organic electro-luminescence (EL). The output unit 14 may further have a speaker function of outputting a sound in addition to the image display function.

The mobile terminal 12B is the terminal device 12 that can be carried by the user U. The mobile terminal 12B is, for example, a tablet terminal or a smartphone. The mobile terminal 12B includes a user interface (UI) unit 26. The UI unit 26 receives various operation inputs by the user U and outputs various types of information. The UI unit 26 includes an output unit 26A and an input unit 26B. The output unit 26A displays various types of information. The output unit 26A is an organic EL, an LCD, or the like. Note that the output unit 26A may have a speaker function of outputting a sound in addition to the display function. The input unit 26B receives various operation inputs from the user U. In the present embodiment, the input unit 26B outputs an operation signal according to an operation instruction of the user U to a control unit of the mobile terminal 12B. The input unit 26B is, for example, a keyboard, a pointing device, a mouse, an input button, or the like. Note that the output unit 26A and the input unit 26B may be integrally configured as a touch panel.

### Configuration of Information Processing Device 10 According to First Embodiment

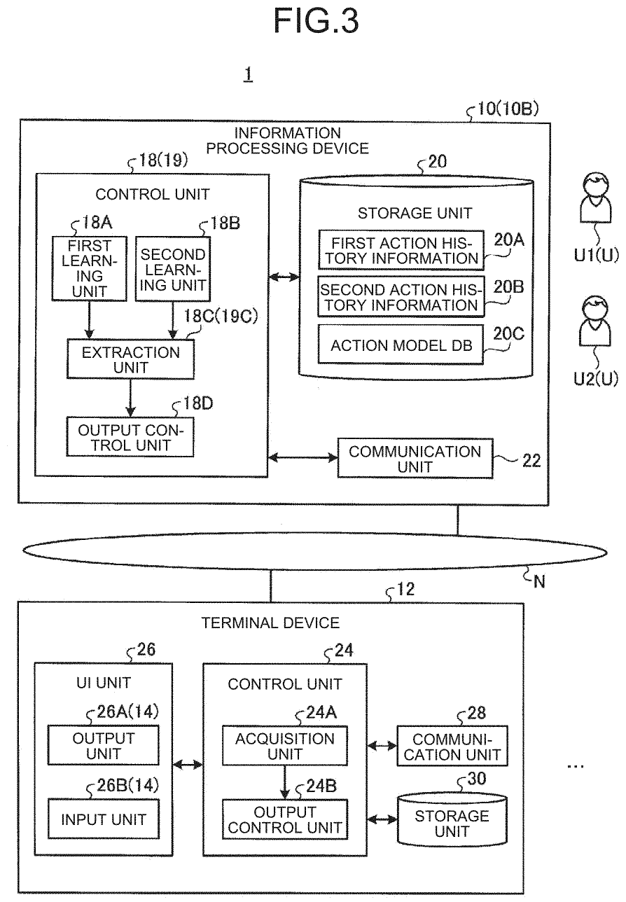

FIG. 3 is an example of a functional block diagram of the information processing device 10 and the terminal device 12.

The information processing device 10 includes a control unit 18, a storage unit 20, and a communication unit 22. The storage unit 20 and the communication unit 22 are connected with the control unit 18 so as to be capable of exchanging data and signals.

The communication unit 22 is a communication interface configured to communicate with various devices such as the terminal device 12 via the network N.

The storage unit 20 stores various types of information. In the present embodiment, the storage unit 20 stores first action history information 20A, second action history information 20B, and an action model DB 20C.

The first action history information 20A is information indicating history of actions of a first user U1. The second action history information 20B is information indicating history of actions of a second user U2. The first user U1 and the second user U2 are examples of the user U. The second user U2 is a user U who has a higher level of proficiency or skill with respect to the content 32 as compared with the first user U1. Note that the first user U1 and the second user U2 will be simply referred to as the user U when generically described.

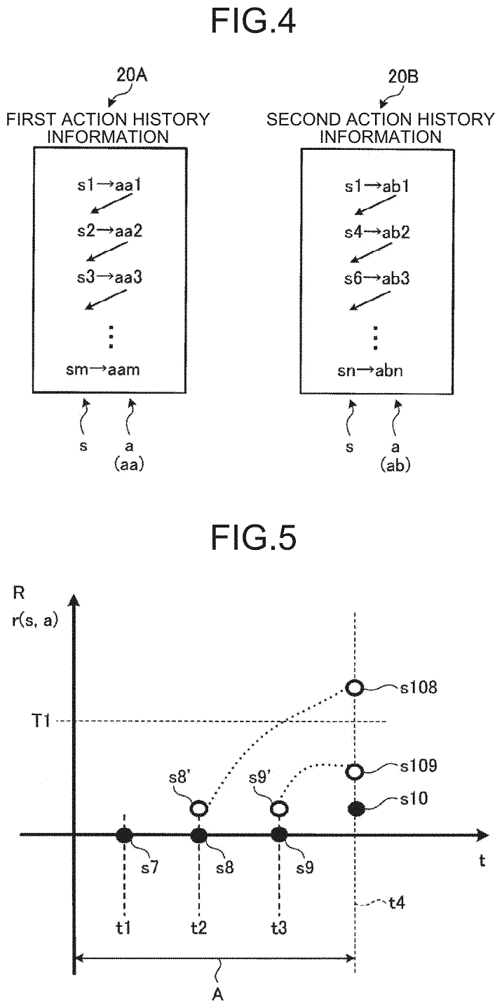

FIG. 4 is a schematic view illustrating examples of data configurations of the first action history information 20A and the second action history information 20B.

The first action history information 20A and the second action history information 20B are represented by a set of correspondences between a situation s of the content 32 and an action a of the user U for the situation s.

The situation s of the content 32 indicates the environment provided by the content 32. The situation s is represented by, specifically, a screen output during a game, a position and an activity state of a character that moves in response to an operation instruction from the user U in the game, a state of the surrounding environment other than the character, a progress status of the game, a game score, and the like. The state of the surrounding environment includes a position and a state of objects other than the character in the game, brightness, weather, and the like. Note that the content 32 is sometimes one that provides an event, such as a sport, conducted by the user U in the real space as the program simulating at least a part of the event as described above. In this case, the situation s may be information indicating a state of the real space. The state of the real space is preferably the environment that changes according to an action of the user U.

The action a of the user U is represented by an action signal indicating the action of the user U. The action signal is information indicating the action a, such as the operation instruction of the input unit 16 input by the user U, and movement (action a) of at least a part of a body of the user U.

That is, the action a indicated by the first action history information 20A and the second action history information 20B is preferably information indicating at least one of the action signal, input by the user U operating the input unit 16 for the situation s provided by the content 32, and a detection result of the action signal indicating the movement of at least a part of the body of the user U in the real space. As the action signal indicating the movement of at least a part of the body of the user U, for example, it is preferable to use a detection result, detected by a known image processing technique for detecting the movement of at least a part of the body of the user U or a known sensor detection technique.

In this manner, the history information of the actions a of the user U indicated by the first action history information 20A and the second action history information 20B may be history information obtained when the user U has previously input an operation using the input unit 16, the input unit 26B or the like for the game provided by the content 32. Further, the history information of the actions a of the user U indicated by the first action history information 20A and the second action history information 20B may be history information when the user U makes movement, such as a sport, corresponding to the content 32 in the real space.

In the content 32, the situation s of the content 32 changes to the next situation s according to the action a such as the operation instruction of the input unit 16 from the user U and the movement of the body. That is, the content 32 outputs the changed situation s according to the input action a. Then, the situation s further changes to the next situation s according to the action a of the user U with respect to the changed situation s. By repeating this, the game, a story, and the like provided by the content 32 progress.

For this reason, the set of correspondences between the situation s of the content 32 and the action a of the user U for the situation s is registered in the first action history information 20A and the second action history information 20B.

Note that at least one of the first action history information 20A and the second action history information 20B may be a time-series set of correspondences between the situation s and the action a of the user U. That is, at least one of the first action history information 20A and the second action history information 20B may be a time-series set indicating the correspondence between the situation s and the action a at each time-series timing. Note that the time-series set may be a continuous or stepwise time-series set, or may be a discrete time-series set.

In the following description, the action a of the first user U1 will be referred to as a first action aa. Further, the action a of the second user U2 will be referred to as a recommended action ab. As described above, the second user U2 is the user U who has a higher level of proficiency or skill for the content 32 as compared with the first user U1. For this reason, the description will be given in the present embodiment by referring to the action a of the second user U2 as the recommended action a for the situation s, that is, the recommended action ab.

FIG. 4 illustrates, as an example of the first action history information 20A, a time-series set of a plurality of situations s (situations s1 to sm (m is an integer of two or more)) corresponding to the respective timings, and the actions a (first actions aa (a first action aa1 to a first action aam)) performed by the first user U1 for each situation s.

Further, FIG. 4 illustrates, as an example of the second action history information 20B, an example of a set of a plurality of situations s (situations s1 to situations sn (n is an integer of two or more)) corresponding to the respective timing, and actions a (recommended actions ab (a recommended action ab1 to a recommended action abn)) performed by the second user U2 for each situation s.

Note that the first action history information 20A may be a set of the first actions aa derived by inputting the situation s into a first action model learned by the control unit 18 which will be described later. In this case, history information obtained by virtually playing the content 32 using the first action model can be used as the first action history information 20A. Further, in this case, the first action history information 20A including a first action aa for an inexperienced situation s of the first user U1 can be obtained. Details of the first action model will be described later.

Similarly, the second action history information 20B may be a set of the recommended actions ab derived by inputting the situation s into a second action model learned by the control unit 18 which will be described later. In this case, history information obtained by virtually playing the content 32 using the second action model can be used as the second action history information 20B. Further, in this case, the second action history information 20B including a recommended action ab for an inexperienced situation s of the second user U2 can be obtained. Details of the second action model will be described later.

Returning to FIG. 3, the description will be continued. The information processing device 10 preferably collects the first action history information 20A and the second action history information 20B from one or a plurality of terminal devices 12 or external devices via the network N, and stores the collected information in the storage unit 20.

Further, as described above, the information processing device 10 may store the first action history information 20A and the second action history information 20B, generated using the action model (first action model and second action model) by the control unit 18, in the storage unit 20.

Next, the action model DB 20C will be described. The action model DB 20C is a database configured to register the action model learned by the control unit 18. Note that a data format of the action model DB 20C is not limited to the database.

Next, the control unit 18 will be described. The control unit 18 controls the information processing device 10.

The control unit 18 includes a first learning unit 18A, a second learning unit 18B, an extraction unit 18C, and an output control unit 18D. Some or all of the first learning unit 18A, the second learning unit 18B, the extraction unit 18C, and the output control unit 18D may be, for example, implemented by causing a processing device such as a CPU to execute a program, that is, by software, implemented by hardware such as an integrated circuit (IC), or implemented using the software and hardware together.

The first learning unit 18A learns the first action model based on the first action history information 20A.

The first action model is an example of the action model. The action model is a learning model to derive the action a from the situation s. In other words, the action model is a classifier or discriminator represented by an algorithm that indicates an action pattern of the user U according to the situation s.

The first action model is a learning model to derive the first action aa from the situation s. The first action model is represented by the following Formula (1), for example.

π(s)→aa Formula (1)

In Formula (1), s represents the situation s provided by the content 32. In Formula (1), aa represents the first action aa of the first user U1 in a certain situation s.

Note that the first action model may be a learning model that indicates the probability of taking a specific first action aa in a certain situation s. In this case, the first action model is expressed by the following Formula (2), for example.

π(aa|s)→[0,1] Formula (2)

In Formula (2), aa and s are the same as those in Formula (1).

The first learning unit 18A uses a pair of the situation s and the first action aa corresponding to each timing illustrated in the first action history information 20A as teacher data. Then, the first learning unit 18A uses the teacher data to learn an action model to derive the first action aa to be performed by the first user U1 in a certain situation s. The first learning unit 18A preferably learns the first action model by known machine learning for learning action imitation of the user U such as known imitation learning.

The second learning unit 18B learns the second action model based on the second action history information 20B. The second action model is an example of the action model. The second action model is a learning model to derive the recommended action ab from the situation s.

The second action model is represented by the following Formula (3), for example.

π′(s)→ab Formula (3)

In Formula (3), s represents the situation s provided by the content 32. In Formula (3), ab represents the recommended action ab of the second user U2 in a certain situation s.

Note that the second action model may be a learning model that indicates the probability of taking a specific recommended action ab in a certain situation s. In this case, the second action model is represented by the following Formula (4), for example.

π′(ab|s)→[0,1] Formula (4)

In Formula (4), ab and s are the same as those in Formula (3) above.

The second learning unit 18B uses a pair of the situation s and the recommended action ab corresponding to each timing illustrated in the second action history information 20B as teacher data. Then, the second learning unit 18B uses the teacher data to learn an action model to derive the recommended action ab to be performed by the second user U2 in a certain situation s. The second learning unit 18B preferably learns the second action model by known machine learning for learning action imitation of the user U such as known imitation learning.

The first learning unit 18A and the second learning unit 18B may classify the learned first action model and second action model according to classification rules and register these action models in the action model DB 20C in association with identification information of each of the classification rules. The classification rules are preferably set in advance. Examples of the classification rules include “for each user U used for learning of these action models”, “for each group to which the user U belongs”, “for each action model application target”, and the like. Note that the classification rules are not limited to these examples.

Next, the extraction unit 18C will be described.

The extraction unit 18C extracts a specific situation of the content 32 based on an action model of the user U. The action model of the user U used for extraction in the specific situation of the content 32 is at least one of the first action model of the first user U1 and the second action model of the second user U2. In the present embodiment, the extraction unit 18C extracts the specific situation based on the first action model of the first user U1.

The specific situation indicates a set of one or a plurality of specific situations s among the situations s included in the content 32. The specific situation may be a time-series set of continuous or stepwise situations s, or a time-series set of discrete situations s. Note that it suffices that the specific situation is a set of one or a plurality of situations s, and the specific situation is not limited to the time-series set.

Specifically, the specific situation is a situation s that is regarded as an abnormality defined in advance in the content 32. For example, when the content 32 is the drive game 32A (see FIG. 2), the situation s regarded as the abnormality is, for example, a situation s where a vehicles is out of a predetermined traveling route, a situation s where the vehicle collides with another vehicle, or the like.

In the present embodiment, the extraction unit 18C extracts, as the specific situation, a situation where an evaluation value of the situation s, output from the content 32 when the first action aa derived from the first action model is input to the content 32 as the action a, is a first threshold or less.

A higher evaluation value indicates a situation closer to a recommended situation s set in advance. Further, a lower evaluation value indicates a larger distance from the recommended situation s set in advance. The state where the evaluation value is the first threshold or less is the situation s regarded as the abnormality defined in advance in the content 32.

As the first threshold, a threshold for discrimination between an abnormal situation s and a normal situation s may be set in advance. In other words, an upper limit value of a range of the evaluation value regarded as the abnormal situation s may be set in advance as the first threshold. Note that the extraction unit 18C may set a first threshold for each content 32 in advance and store the first threshold in the storage unit 20 in association with identification information of the content 32. Then, when extracting a specific situation, it suffices that the extraction unit 18C reads the first threshold corresponding to the identification information of the content 32 that is an extraction target of the specific situation from the storage unit 20 and uses the read first threshold for the extraction of the specific situation.

The extraction unit 18C introduces the situation s provided by the content 32 into the first action model to obtain the first action aa for the situation s. Then, the extraction unit 18C inputs the obtained first action aa into the content 32 as the action a to obtain the next situation s thus changed. Then, the extraction unit 18C repeatedly executes this processing. That is, the extraction unit 18C virtually executes the game implemented by the content 32 using the first action model.

A model indicating the content 32 is represented by the following Formula (5), for example.

T(s,a)→s Formula (5)

Formula (5) indicates that the next situation s is output when the action a, which is a certain situation s, is input.

The extraction unit 18C calculates an evaluation value of the situation s every time the new situation s after the change is output from the content 32 by the input of the first action aa (action a).

The extraction unit 18C calculates a higher evaluation value as a content indicated by the situation s is closer to the predetermined recommended situation s in the content 32 that provides the situation s. A method for calculating the evaluation value is preferably set in advance according to the content 32.

For example, the extraction unit 18C calculates the evaluation value using a situation determination function. The situation determination function is represented by the following Formula (6) or Formula (7), for example.

r(s)→R Formula (6)

r(s,a)→R Formula (7)

Formula (6) is a formula illustrating a situation determination function r to derive an evaluation value R for a certain situation s. Formula (7) is a formula illustrating a situation determination function r to derive an evaluation value R at the time of performing an action a which is a situation s.

The extraction unit 18C introduces the changed situation s output from the content 32 or the changed situation s and the action a as the first action aa input to the changed situation s to the above Formula (6) or Formula (7) to calculate the evaluation value R.

Then, the extraction unit 18C determines that the situation s for which the calculated evaluation value R is the first threshold or less is the situation s with the poor evaluation value R, that is, with a larger distance from the recommended situation s, and extracts the situation s as a specific situation.

Through the above process, the extraction unit 18C extracts the specific situation of the content 32 based on the first action model of the first user U1.

Note that the extraction unit 18C may further extract an occurrence factor of the extracted specific situation.

In this case, the extraction unit 18C further extracts a correspondence between a situation s during a period prior to an occurrence timing of a specific situation and the first action aa as the occurrence factor of the specific situation.

Specifically, the extraction unit 18C virtually executes the game implemented by the content 32 using the first action model. Then, the extraction unit 18C not only identifies a specific situation but also identifies an occurrence timing of the specific situation as described above. Furthermore, the extraction unit 18C extracts a correspondence between at least one situation s and the first action aa input in the situation s among a time-series set of the situation s during the period prior to the occurrence timing of the specific situation, as the occurrence factor of the specific situation.

FIG. 5 is an explanatory view illustrating an example of extraction of the occurrence factor. Note that the vertical axis represents the evaluation value R represented by the situation determination function r(s,a), and the horizontal axis represents the timing, in the graph illustrated in FIG. 5.

For example, it is assumed that an evaluation value R of a situation s10 at a timing t4 falls within a range of the first threshold T1 or less. In this case, the extraction unit 18C extracts the situation s10 at the timing t4 as a specific situation. Further, the extraction unit 18C identifies the timing t4 as the occurrence timing t4 of the specific situation.

Then, the extraction unit 18C inputs correction actions, obtained by correcting the first action aa for each of situations s at timings before the occurrence timing t4 (a situation s9, a situation s8, and a situation s7 in FIG. 5) among the situations s during a period A prior to the occurrence timing t4 of the specific situation, to the content 32 as the action a.

Specifically, the extraction unit 18C traces back the situations s one by one toward the (past) timing prior to the occurrence timing t4, and corrects the first action aa performed for the traced situation s to a correction action having a value different from that of the first action aa every time the situation s is traced back. Then, the corrected correction action is input to the content 32 as the action a for the timing of the situation s.

In the case of the example illustrated in FIG. 5, the extraction unit 18C corrects the first action aa input for the situation s9 at the timing t3, which is one situation s back from the timing t4, to the correction action. Then, the extraction unit 18C inputs the correction action into the content 32 as the action a corresponding to the timing t3 to obtain a corrected situation s9′.

Note that the extraction unit 18C may use the recommended action ab of the second user U2 for the traced situation s as the correction action. That is, the extraction unit 18C may use the recommended action ab of the second user U2 input for the traced situation s as the correction action.

In this case, the extraction unit 18C preferably acquires the recommended action ab for the situation s by inputting the traced situation s into the second action model learned by the second learning unit 18B.

Note that the extraction unit 18C may acquire the recommended action ab for the situation s by reading the recommended action ab corresponding to the traced situation s from the second action history information 20B. When the extraction unit 18C reads the recommended action ab from the second action history information 20B, a configuration in which the control unit 18 does not include the second learning unit 18B may be adopted.

The extraction unit 18C inputs the correction action to the content 32 as the action a for the situation s of the traced timing, and then, virtually executes the content 32 using the first action model toward the occurrence timing t4 of the specific situation.

Then, the extraction unit 18C traces the situations s back one by one toward the (past) timing prior to the occurrence timing t4 until determining that the evaluation value R of the situation s output from the content 32 at the occurrence timing t4 of the specific situation exceeds the first threshold T1, and repeatedly executes the input of the correction action to the content 32 and the determination on the evaluation value R of the situation s at the occurrence timing t4.

Then, the extraction unit 18C preferably extract a correspondence between a situation s at the timing when the evaluation value R of the situation s output from the content 32 at the occurrence timing t4 exceeds the first threshold T1, and the first action aa for the situation s, as an occurrence factor.

As illustrated in FIG. 5, it is assumed that the situation s9 at the timing t3, which is one situation s back from the occurrence timing t4, is changed to the situation s9′ by the correction of the first action aa. Then, it is assumed that the situation s output from the content 32 at the occurrence timing t4 by the virtual execution of the content 32 using the first action model thereafter is a situation s109 that is equal to or less than the first threshold T1 in this case.

Then, it is assumed that the situation s8 of the situation s8 at a timing t2, which is obtained by tracing one more situation s back from the timing t3, is changed to a situation s8′ by the correction of the first action aa. Then, it is assumed that the situation s output from the content 32 at the occurrence timing t4 by the virtual execution of the content 32 using the first action model thereafter is a situation s108 that exceeds the first threshold T1 in this case.

In this case, the extraction unit 18C extracts a correspondence between the situation s8 at the timing t2 and the first action aa of the first user U1 for the situation s8 as the occurrence factor of the specific situation (situation s10) at the occurrence timing t4.

In this manner, the extraction unit 18C inputs the correction action, obtained by correcting the first action aa for the situation s during the period prior to the occurrence timing t4 of the specific situation, into the content 32. Then, the extraction unit 18C extracts a correspondence between a situation s at a timing t, which is closest to the occurrence timing t4 and at which the evaluation value R of the situation s output from the content 32 exceeds the first threshold T1 at the occurrence timing t4 when the correction action is input to the content 32 during the previous period, and the first action aa as the occurrence factor.

Returning to FIG. 3, the description will be continued. Next, the output control unit 18D will be described. The output control unit 18D outputs advice information regarding a specific situation.

The output control unit 18D receives the specific situation from the extraction unit 18C. Note that the output control unit 18D may receive both the specific situation and the occurrence factor from the extraction unit 18C. Then, the extraction unit 18C outputs the advice information regarding the specific situation. Note that the extraction unit 18C may output the advice information regarding the specific situation and the occurrence factor.

The advice information is information that provides advice to the first user U1 regarding a specific situation. Specifically, the advice information indicates at least one of a content of the specific situation, an occurrence factor of the specific situation, and a method for avoiding the specific situation.

The content of the specific situation is information indicating a situation s indicated by the specific situation and a first action aa of the first user U1 with respect to the situation s. The situation s indicated by specific information is represented by a screen output during a game, a position and an activity state of a character that moves in response to an operation instruction from the first user U1 in the game, a state of the surrounding environment other than the character, a progress status of the game, a game score, and the like. Further, the content of the specific situation may include information indicating a position and an occurrence timing of the specific situation in the content 32. In addition, the content of the specific situation may include information indicating that a location indicated by the position or the occurrence timing of the specific situation is a location that should call the attention of the first user U1.

The occurrence factor of the specific situation may be information indicating a correspondence between the situation s indicating the occurrence factor extracted by the extraction unit 18C and the first action aa of the first user U1. For example, the occurrence factor may be information indicating what kind of action performed by the first user U1 in a certain situation s causes the situation s indicated by the specific situation at the occurrence timing.

The method for avoiding the specific situation is information indicating an action a taken by the first user U1 in order to avoid the specific information. The method for avoiding the specific situation is, for example, information indicating a recommended action ab corresponding to a situation s indicated by the specific situation or information indicating a recommended action ab corresponding to a situation s indicated by the occurrence factor.

The output control unit 18D preferably generates and outputs the advice information using the specific situation received from the extraction unit 18C, or the specific situation and the occurrence factor.

In the present embodiment, the output control unit 18D transmits advice information regarding the specific situation to the terminal device 12 that can provide the information to the first user U1 to output the advice information.

For example, the output control unit 18D preferably transmits the advice information regarding the specific situation to the terminal device 12 operated by the first user U1 via the communication unit 22 and the network N. In this case, for example, the storage unit 20 preferably stores identification information of the first user U1 and identification information of the terminal device 12 operated by the first user U1 in association with each other in advance. Then, the output control unit 18D preferably reads the identification information of the terminal device 12 operated by the first user U1, which corresponds to the identification information of the first user U1 to be provided, from the storage unit 20 and transmits the advice information to the terminal device 12 identified by the identification information.

Note that the output control unit 18D may output the advice information regarding the specific situation to an output device such as a display device directly connected to the information processing device 10.

### Configuration of Terminal Device According to First Embodiment

Next, the terminal device 12 will be described. The terminal device 12 outputs the advice information received from the information processing device 10.

The terminal device 12 includes a control unit 24, the UI unit 26, a communication unit 28, and a storage unit 30. The UI unit 26, the communication unit 28, the storage unit 30, and the control unit 24 are connected so as to be capable of exchanging data and signals.

The UI unit 26 includes the output unit 26A and the input unit 26B as described above. Note that the output unit 26A corresponds to the output unit 14, and the input unit 26B corresponds to the input unit 16 when the terminal device 12 is the game device 12A.

The communication unit 28 is a communication interface that communicates with the information processing device 10 and other devices via the network N. The storage unit 30 stores various types of information.

The control unit 24 controls the terminal device 12. The control unit 24 includes an acquisition unit 24A and an output control unit 24B. One or all of the acquisition unit 24A and the output control unit 24B may be, for example, implemented by causing a processing device such as a CPU to execute a program, that is, by software, implemented by hardware such as an IC, or implemented using the software and hardware together.

The acquisition unit 24A acquires the advice information from the information processing device 10. The output control unit 24B outputs the advice information to the UI unit 26. In the present embodiment, the output control unit 24B displays a display screen illustrating the advice information on the UI unit 26.

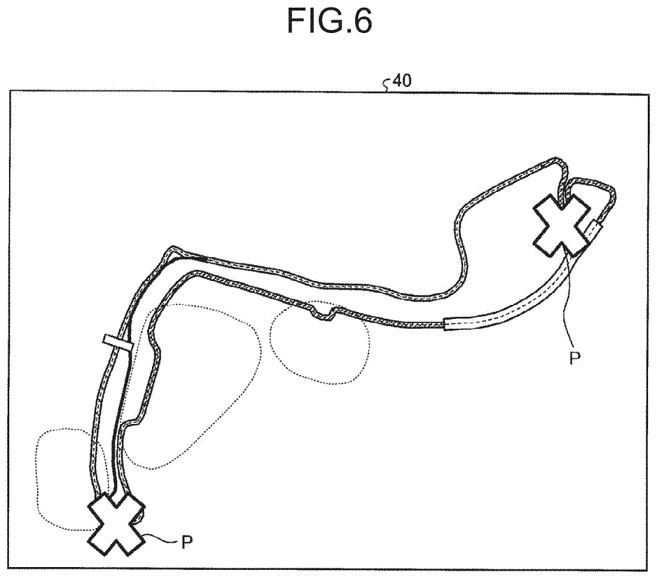

FIG. 6 is a schematic view illustrating an example of a display screen 40. FIG. 6 illustrates a case where the content 32 is the drive game 32A (see FIG. 2) as an example. In this case, the output control unit 24B of the terminal device 12 generates the display screen 40 in which an icon P indicating advice information is arranged on a game screen provided by the drive game 32A, and outputs the display screen 40 to the UI unit 26. Note that the generation of the display screen 40 may be executed by the output control unit 18D of the information processing device 10.

For example, the first user U1 selects a display position of the icon P on the display screen 40 by operating the UI unit 26 (the input unit 26B or the input unit 16). The output control unit 24B preferably displays details of advice information corresponding to the selected icon P on the UI unit 26 when receiving a selection signal indicating the selection from the UI unit 26. Note that a display form of the advice information is not limited to the form illustrated in FIG. 6.

Returning to FIG. 3, the description will be continued. An output timing of the advice information in the terminal device 12 is not limited. For example, the control unit 24 displays the advice information on the UI unit 26 when a game start instruction signal is received by an operation instruction of the UI unit 26 by the first user U1. Further, for example, the control unit 24 may output the advice information to the UI unit 26 while the terminal device 12 is executing a game program of the content 32. In this case, the control unit 24 preferably outputs the advice information to the UI unit 26 when a situation s provided by the content 32 becomes a specific situation or a situation s of an occurrence factor indicated in the advice information, or becomes close to the specific situation.

### Information Processing Procedure According to First Embodiment

Next, an example of an information processing procedure executed by the information processing device 10 will be described.

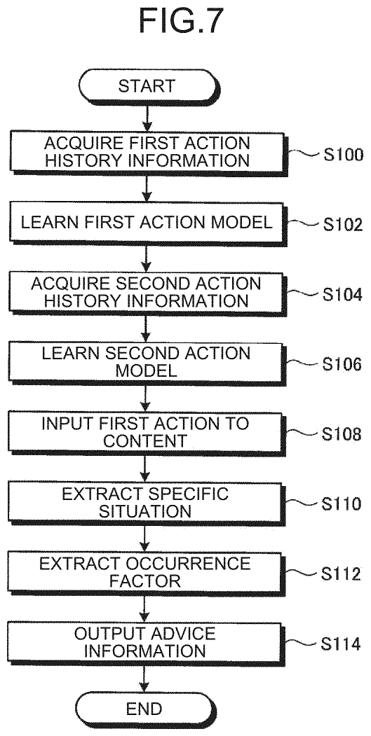

FIG. 7 is a flowchart illustrating an example of the information processing procedure executed by the information processing device 10.

First, the first learning unit 18A acquires the first action history information 20A from the storage unit (Step S100). Next, the first learning unit 18A learns the first action model based on the first action history information 20A acquired in Step S100 (Step S102).

Next, the second learning unit 18B acquires the second action history information 20B from the storage unit (Step S104). Next, the second learning unit 18B learns the second action model based on the second action history information 20B acquired in Step S104 (Step S106).

Next, the extraction unit 18C virtually executes the game implemented by the content 32 using the first action model learned in Step S102 (Step S108). That is, in Step 108, the extraction unit 18C sequentially inputs first actions aa derived from the first action model as actions a to the content 32 and obtains sequentially output situations s.

Next, the extraction unit 18C extracts a specific situation of the content 32 based on the evaluation values R of the situations s sequentially output from the content 32 in Step S108 based on the first action model of the first user U1 learned in Step S102 (Step S110).

Next, the extraction unit 18C extracts an occurrence factor of the specific situation extracted in Step S110 (Step S112).

Next, the output control unit 18D outputs advice information regarding the specific situation extracted in Step S110 and the occurrence factor extracted in Step S112 to the terminal device 12 (Step S114). Then, this routine is ended.

Note that the control unit 18 may execute at least one process of the learning of the first action model and the learning of the second action model in Steps S100 to S106 at a timing different from the extraction of the specific situation by the extraction unit 18C. Specifically, the series of processes of Steps S100 to S106 may be executed at a timing different from the series of processes of Steps S108 to S114.

### Output Processing Procedure According to First Embodiment

Next, an example of an output processing procedure executed by the terminal device 12 will be described.

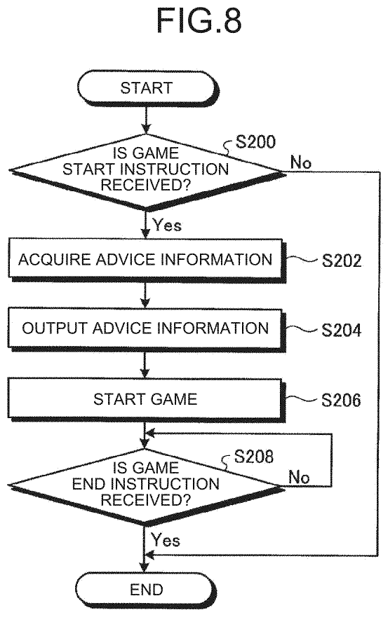

FIG. 8 is a flowchart illustrating an example of the output processing procedure executed by the terminal device 12. Note that a case where the terminal device 12 is the game device 12A and a game program is executed as the content 32 will be described as an example in FIG. 8.

First, the acquisition unit 24A of the terminal device 12 determines whether or not the game start instruction signal has been received from the input unit 16 (Step S200). If it is determined to be negative in Step S200 (Step S200: No), this routine is ended. On the other hand, if it is determined to be affirmative in Step S200 (Step S200: Yes), the processing proceeds to Step S202.

In Step S202, the acquisition unit 24A acquires advice information from the information processing device 10 via the communication unit 28. Note that the control unit 24 of the terminal device 12 may store the advice information received from the information processing device 10 in the storage unit 30. Then, the acquisition unit 24A may acquire advice information by reading the advice information from the storage unit 30.

Then, the output control unit 24B outputs the advice information to the UI unit 26 (Step S204). For this reason, the display screen 40 including the icon P indicating the advice information, for example, illustrated in FIG. 6 is displayed on the UI unit 26 of the terminal device 12.

Then, the control unit 24 executes the game program corresponding to the game start instruction signal received in Step S200 (Step S206). Then, the control unit 24 repeats the negative determination until determining that the game end instruction has been received from the input unit 16 (Step S208: No), and ends this routine if an affirmative determination is made (Step S208: Yes). Note that the control unit 24 may output the advice information to the UI unit 26 during the execution of the game as described above.

As described above, the information processing device 10 of the present embodiment includes the extraction unit 18C and the output control unit 18D. The extraction unit 18C extracts the specific situation of the content 32 whose situation changes according to the action of the user U based on the action model of the user U. The output control unit 18D outputs advice information regarding a specific situation.

Here, conventionally, a content for training is prepared for learning of a technique step by step. For example, in the case of the drive game, a content for training, such as a smooth acceleration method and a method for entering a corner, is separately prepared. However, the content for training is uniform so that it is difficult to provide advice information according to the action of the user U.

On the other hand, the extraction unit 18C extracts the specific situation based on the action model of the user U in the present embodiment. Then, the output control unit 18D outputs the advice information regarding the specific situation extracted based on the action model of the user U.

Therefore, the information processing device 10 of the present embodiment can provide the advice information according to the action of the user U.

Further, in the present embodiment, the first learning unit 18A learns the first action model as the action model to derive the first action aa from the situation s based on the first action history information 20A indicating the correspondence between the situation s and the first action aa of the first user U1 serving as the user U. The extraction unit 18C extracts, as the specific situation, the situation s where the evaluation value R of the situation s, output from the content 32 when the first action aa derived from the first action model is input as the action a, is the first threshold T1 or less.

In this manner, the information processing device 10 of the present embodiment obtains the first action aa of the first user U1 for the input to the content 32 using the first action model. For this reason, even if at least one of the situations s provided by the content 32 is not registered in the first action history information 20A, the information processing device 10 can obtain the first action aa according to the situation s provided by the content 32. Then, the extraction unit 18C of the information processing device 10 extracts the specific situation using the evaluation value R of the situation s output from the content 32 when the first action aa derived from the first action model is input as the action a.

For this reason, the information processing device 10 according to the present embodiment can accurately extract the specific situation in addition to the above effects.

Further, in the present embodiment, the extraction unit 18C further extracts the correspondence between the situation s during the period prior to the occurrence timing of the specific situation and the first action aa as the occurrence factor of the specific situation.

Since the occurrence factor of the specific situation is further extracted in this manner, the information processing device 10 of the present embodiment can provide the user U with appropriate advice information in addition to the above effects.

Further, in the present embodiment, the extraction unit 18C extracts the correspondence between the situation s and the first action aa as the occurrence factor, the situation s having the evaluation value R, output from the content 32 at the occurrence timing, exceeding the first threshold T1 when the correction action obtained by correcting the first action aa is input as the action a in the content 32 among the situations s during the period prior to the occurrence timing of the specific situation.

That is, the extraction unit 18C extracts a situation s in which the evaluation value R of the situation s at the occurrence timing is favorable when a first action aa for the situation s is changed to a correction action that is another action a among the situations s during the period prior to the occurrence timing of the specific situation, and the first action aa performed for the situation s as the occurrence factors.

For this reason, the information processing device 10 according to the present embodiment can accurately extract the occurrence factor in addition to the above effects.

### Modification of First Embodiment

In the present modification, action history information is generated by correcting the first action history information 20A of the first user U1, and a recommended situation is extracted based on an action model learned based on the action history information.

### Configuration of Information Processing System According to Modification of First Embodiment

FIG. 1 is a schematic diagram illustrating an example of an information processing system 1A of the present modification.

The information processing system 1A includes an information processing device 10A and the terminal device 12. The information processing system 1A is the same as the information processing system 1 of the first embodiment except that the information processing device 10A is provided instead of the information processing device 10.

### Configuration of Information Processing Device According to Modification of First Embodiment

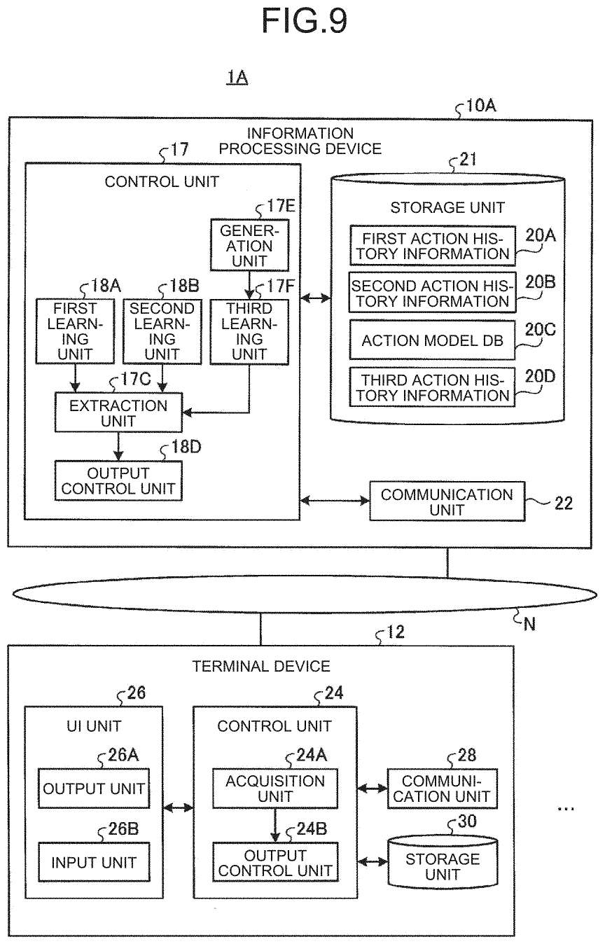

FIG. 9 is an example of a functional block diagram of the information processing device 10A and the terminal device 12. The functional configuration of the terminal device 12 is similar to that of the first embodiment.

The information processing device 10A includes a control unit 17, a storage unit 21, and the communication unit 22. The storage unit 21, the communication unit 22, and the control unit 17 are connected so as to be capable of exchanging data and signals. The communication unit 22 is similar to that of the first embodiment.

The storage unit 21 stores various types of information. In the present modification, the storage unit 21 stores the first action history information 20A, the second action history information 20B, third action history information 20D, and the action model DB 20C. The first action history information 20A, the second action history information 20B, and the action model DB 20C are the same as those in the first embodiment.

The third action history information 20D is action history information obtained by correcting the first action history information 20A. The third action history information 20D is generated by processing of the control unit 17 and stored in the storage unit 21 (details will be described later).

The control unit 17 controls the information processing device 10A. The control unit 17 includes the first learning unit 18A, the second learning unit 18B, a generation unit 17E, a third learning unit 17F, an extraction unit 17C, and the output control unit 18D. Some or all of the first learning unit 18A, the second learning unit 18B, the generation unit 17E, the third learning unit 17F, the extraction unit 17C, and the output control unit 18D may be, for example, implemented by causing a processing device such as a CPU to execute a program, that is, by software, implemented by hardware such as an IC, or implemented using the software and hardware together. The first learning unit 18A, the second learning unit 18B, and the output control unit 18D are the same as those in the first embodiment.

The generation unit 17E corrects the first action history information 20A of the first user U1 and generates the third action history information 20D.

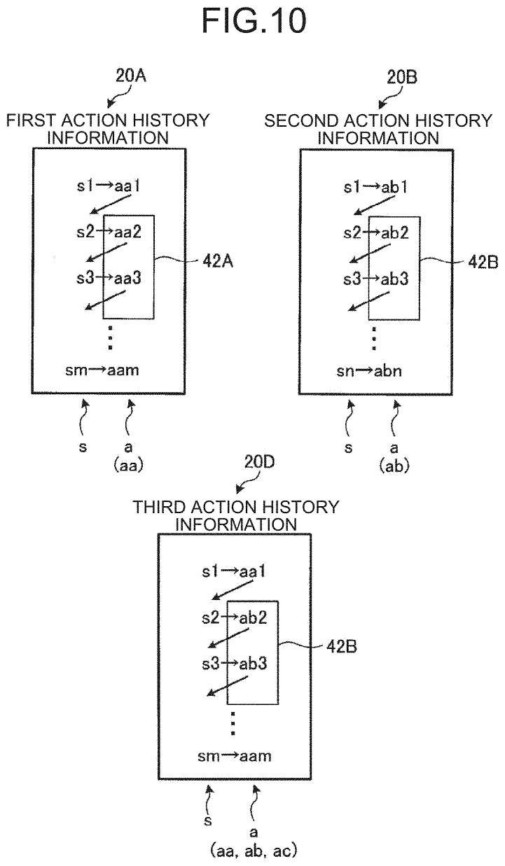

FIG. 10 is an explanatory view illustrating an example of generation of the third action history information 20D.

The generation unit 17E generates the third action history information 20D by replacing a first action aa whose difference from a recommended action ab is a predetermined value or more among the first actions aa of the first action history information 20A with the recommended action ab based on the first action history information 20A and the second action history information 20B.

Specifically, the generation unit 17E compares the first action aa and the recommended action ab corresponding to the same situation s based on the first action history information 20A and the second action history information 20B. In other words, the generation unit 17E compares the first action aa and the recommended action ab having a correspondence for the same situation s based on the first action history information 20A and the second action history information 20B.

Then, the generation unit 17E identifies the situation s in which the difference between the first action aa and the recommended action ab having the correspondence is the predetermined value or more among one or more situations s defined in the first action history information 20A.

Here, the first action aa is a more normal or favorable action a as the difference between the first action aa and the recommended action ab is smaller. Further, the first action aa is a more abnormal or poorer action a as the difference between the first action aa and the recommended action ab is larger.

For this reason, a lower limit value of a range of the difference between the first action aa and the recommended action ab, which is regarded as the abnormal or poor action a, may be set in advance as the predetermined value. Note that the generation unit 17E may set a predetermined value for each of the content 32 and the user U in advance, and store the predetermined value in the storage unit 21 in advance in association with identification information of the content 32 and the user U. Then, it suffices that the generation unit 17E reads a predetermined value corresponding to identification information of the content 32 and the user U to be processed from the storage unit 21 at the time of generating the third action history information 20D, and uses the read predetermined value to generate the third action history information 20D.

Next, the generation unit 17E replaces a first action aa corresponding to a situation s, identified as having the difference equal to or larger than the predetermined value among the first actions aa corresponding to one or more situations s defined in the first action history information 20A, with a recommended action ab corresponding to the same situation s in the second action history information 20B. With this replacement, the generation unit 17E generates the third action history information 20D.

Specifically, as illustrated in FIG. 10, it is assumed that a difference between a first action aa2 corresponding to a situation s2 of the first action history information 20A and a recommended action ab2 corresponding to the same situation s2 of the second action history information 20B is a predetermined value or more. Further, it is assumed that a difference between a first action aa3 corresponding to a situation s3 of the first action history information 20A and a recommended action ab3 corresponding to the same situation s3 of the second action history information 20B is the predetermined value or more. In this case, the generation unit 17E replaces the first action aa2 and the first action aa3 of the first action history information 20A (see the inside of a frame line 42A in FIG. 10) with the recommended action ab2 and the recommended action ab3 of the second action history information 20B (see the inside of a frame line 42B in FIG. 10). With this processing, the generation unit 17E generates the third action history information 20D.

Returning to FIG. 9, the description will be continued. The third learning unit 17F learns a third action model as an action model to derive a third action ac in the third action history information 20D from the situation s based on the third action history information 20D. The third action ac is the action a defined in the third action history information 20D, and is represented by the first action aa of the first action history information 20A and the recommended action ab of the second action history information 20B as illustrated in FIG. 10.

Returning to FIG. 9, the description will be continued. The third action model is an example of the action model. The third action model is a learning model to derive the third action ac from the situation s.

The third learning unit 17F preferably learns the third action model in the same manner as the first learning unit 18A using teacher data indicating a correspondence between the situation s and the third action ac corresponding to each timing indicated in the third action history information 20D.

Next, the extraction unit 17C will be described.

The extraction unit 17C extracts, as a specific situation, a situation s where the evaluation value R of the situation s, output from the content 32 when the third action ac derived from the third action model is input as the action a, exceeds a third threshold.

That is, the extraction unit 17C extracts the specific situation similarly to the extraction unit 18C of the first embodiment except that the evaluation value R is calculated using the third action model instead of the first action model and the second action model.

Here, as described above, the third action history information 20D is action history information generated by replacing the first action aa whose difference from the recommended action ab is the predetermined value or more in the first action history information 20A with the recommended action ab.

For this reason, the extraction unit 17C extracts, as the specific situation, the situation s in which the evaluation value R is improved by replacing the first action aa with the recommended action ab in the present modification.

That is, the extraction unit 17C uses the third threshold to determine the evaluation value R in the present modification. A lower limit value of a range of the evaluation value R to determine that the situation s has been improved by replacing the first action aa with the recommended action ab may be set as the third threshold. Then, the extraction unit 17C may extract the situation s in which the evaluation value R is the third threshold or more as the specific situation.

Note that the extraction unit 17C may further extract the occurrence factor of the specific situation similarly to the extraction unit 18C of the first embodiment. The extraction of the occurrence factor of the specific situation may be performed in the same manner as the extraction unit 18C.

### Information Processing Procedure According to Modification of First Embodiment

Next, an example of an information processing procedure executed by the information processing device 10A will be described.

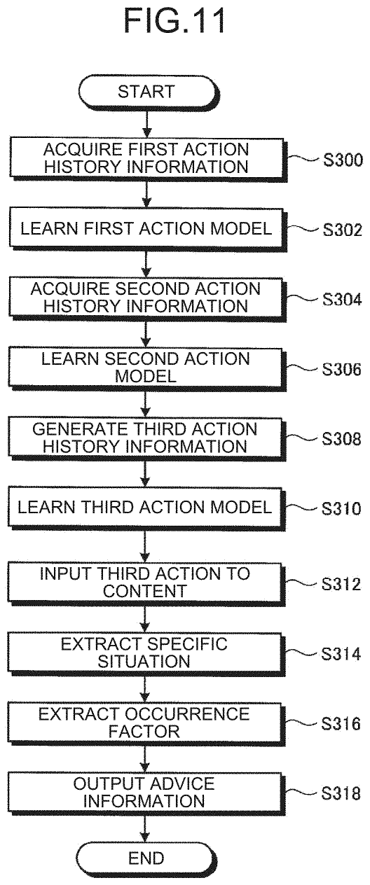

FIG. 11 is a flowchart illustrating an example of the information processing procedure executed by the information processing device 10.

First, the first learning unit 18A acquires the first action history information 20A from the storage unit (Step S300). Next, the first learning unit 18A learns the first action model based on the first action history information 20A acquired in Step S300 (Step S302).

Next, the second learning unit 18B acquires the second action history information 20B from the storage unit (Step S304). Next, the second learning unit 18B learns the second action model based on the second action history information 20B acquired in Step S304 (Step S306).

Next, the generation unit 17E generates the third action history information 20D using the first action history information 20A and the second action history information 20B (Step S308). Next, the third learning unit 17F learns the third action model based on the third action history information 20D generated in Step S308 (Step S310).

Next, the extraction unit 17C virtually executes the game implemented by the content 32 using the third action model learned in Step S310 (Step S312). That is, in Step 312, the extraction unit 17C sequentially inputs third actions ac derived from the third action model as actions a to the content 32.

Next, the extraction unit 17C extracts a specific situation of the content 32 based on the evaluation values R of the situations s sequentially output from the content 32 in Step S312 based on the third action model learned in Step S310 (Step S314).

Next, the extraction unit 18C extracts an occurrence factor of the specific situation extracted in Step S314 (Step S316).

Next, the output control unit 18D outputs advice information regarding the specific situation extracted in Step S316 and the occurrence factor extracted in Step S316 to the terminal device 12 (Step S318). Then, this routine is ended.

As described above, in the present modification, the generation unit 17E generates the third action history information 20D obtained by replacing the first action aa whose difference from the recommended action ab in the second action history information 20B is the predetermined value or more among the first actions aa of the first action history information 20A with the recommended action ab based on the first action history information 20A and the second action history information 20B. The third learning unit 17F learns the third action model as the action model to derive the third action ac as the first action aa and the recommended action ab in the third action history information 20D from the situation s based on the third action history information 20D. The extraction unit 17C extracts, as a specific situation, a situation s where the evaluation value R of the situation s, output from the content 32 when the third action ac derived from the third action model is input as the action a, is the third threshold or more.

Thus, in the present modification, the generation unit 17E generates the third action history information 20D obtained by correcting the first action history information 20A of the first user U1 using the second action history information 20B of the second user U2 having a higher level of proficiency or skill for the content 32 than the first user U1. Then, the extraction unit 17C extracts the specific situation based on the third action model of the user U learned from the third action history information 20D.

For this reason, the information processing device 10A of the present modification can provide the advice information according to the action a of the user U.

### Second Embodiment

In the present embodiment, a description will be given regarding a form of extracting a specific situation based on a difference between a first action aa defined in the first action history information 20A of the first user U1 and a recommended action ab derived from the second action model of the second user U2.

### Configuration of Information Processing System According to Second Embodiment

FIG. 1 is a schematic diagram illustrating an example of an information processing system 1B of the present modification.

The information processing system 1B includes an information processing device 10B and the terminal device 12. The information processing system 1B is the same as the information processing system 1 of the first embodiment except that the information processing device 10B is provided instead of the information processing device 10.

### Configuration of Information Processing Device According to Second Embodiment

FIG. 3 is an example of a functional block diagram of the information processing device 10B and the terminal device 12. The functional configuration of the terminal device 12 is similar to that of the first embodiment.

The information processing device 10B includes a control unit 19, the storage unit 20, and the communication unit 22. The storage unit 21, the communication unit 22, and the control unit 19 are connected so as to be capable of exchanging data and signals. The storage unit 20 and the communication unit 22 are the same as those in the first embodiment.

The control unit 19 controls the information processing device 10B. The control unit 19 includes the first learning unit 18A, the second learning unit 18B, an extraction unit 19C, and the output control unit 18D. Some or all of the first learning unit 18A, the second learning unit 18B, the extraction unit 19C, and the output control unit 18D may be, for example, implemented by causing a processing device such as a CPU to execute a program, that is, by software, implemented by hardware such as an IC, or implemented using the software and hardware together. The first learning unit 18A, the second learning unit 18B, and the output control unit 18D are the same as those in the first embodiment.

The extraction unit 19C extracts a situation s where a difference between a first action aa and a recommended action ab is a second threshold or more as a specific situation based on the first action history information 20A indicating a correspondence between the situation s and the first action aa of the first user U1, and the second action model.

Specifically, in the present embodiment, the second learning unit 18B of the control unit 19 learns the second action model from the second action history information 20B similarly to the first embodiment.

Then, the extraction unit 19C introduces each of the situations s indicated in the first action history information 20A into the second action model to obtain a recommended action ab for the situation s.

Here, there is a case where a situation s indicated in the first action history information 20A and a situation s indicated in the second action history information 20B do not coincide at least partially. As described above, the situation s to be output from the content 32 changes according to the input action a of the user U. For this reason, when actions a of the first user U1 and the second user U2 for a certain situation s are different, changed situations s output from the content 32 are different. For this reason, there is a case where the situation s indicated in the first action history information 20A and the situation s indicated in the second action history information 20B do not coincide at least partially.

Then, at least some situations s among a plurality of situations s indicated in the first action history information 20A are not indicated in the second action history information 20B in some cases. In other words, the situations s changed by the first action aa by the first user U1 include a situation s that does not occur by the recommended action ab of the second user U2 in some cases.

Therefore, the extraction unit 19C introduces each of the situations s indicated in the first action history information 20A into the second action model to derive the recommended action ab corresponding to the situation s in the present embodiment.

Then, the extraction unit 19C calculates, for each of the situations s indicated in the first action history information 20A, a difference between a corresponding first action aa and the corresponding recommended action ab derived using the second action model.

Then, the extraction unit 19C extracts a situation s in which the difference between the first action aa and the recommended action ab is the second threshold or more as the specific situation.

Here, the first action aa is a more normal or favorable action a as the difference between the first action aa and the recommended action ab is smaller. Further, the first action aa is a more abnormal or poorer action as the difference between the first action aa and the recommended action ab is larger.

For this reason, a lower limit value of a range of the difference between the first action aa and the recommended action ab, which is regarded as the abnormal or poor action a, may be set in advance as the second threshold. Note that the extraction unit 19C may set a second threshold in advance for each of the content 32, the first user U1, and the second user U2, and store the second threshold in the storage unit 20 in advance in association with the identification information. Then, when extracting a specific situation, it suffices that the extraction unit 19C reads the second threshold corresponding to the identification information of the first user U1, the second user U2, and the content 32 to be processed from the storage unit 20 and uses the read second threshold for the extraction of the specific situation.

With the above processing, the extraction unit 19C extracts the situation s where the difference between the first action aa and the recommended action ab is the second threshold or more as the specific situation based on the first action history information 20A of the first user U1 and the second action model of the second user U2.

Note that the extraction unit 19C may calculate a degree of deviation between a set of continuous first actions aa in the first action history information 20A and a set of continuous recommended actions ab in the second action history information 20B as the difference, and extracts a situation s in which the difference is the second threshold or more as the specific situation.

Note that the extraction unit 19C may further extract an occurrence factor of the extracted specific situation similarly to the extraction unit 18C of the first embodiment. The extraction of the occurrence factor is preferably executed using the first action model learned by the first learning unit 18A similarly to the first embodiment. Note that a configuration in which the control unit 19 does not include the first learning unit 18A may be adopted if the information processing device 10B does not extract the occurrence factor of the specific situation.

The output control unit 18D outputs advice information regarding a specific situation similarly to the first embodiment.

Here, the specific situation is the situation s where the difference between the first action aa and the recommended action ab is the second threshold or more in the present embodiment. For this reason, the advice information may further include information indicating the difference between the first action aa of the first user U1 and the recommended action ab of the second user U2.

Specifically, the advice information is preferably information indicating at least one of a content of the specific situation, an occurrence factor of the specific situation, a difference between the action a of the user U and the recommended action ab for the specific situation, and a method for avoiding the specific situation.

Since the advice information includes the information indicating the difference between the first action aa of the first user U1 and the recommended action ab of the second user U2 as the information regarding the specific situation, the information output by the terminal device 12 may include information indicating the difference.

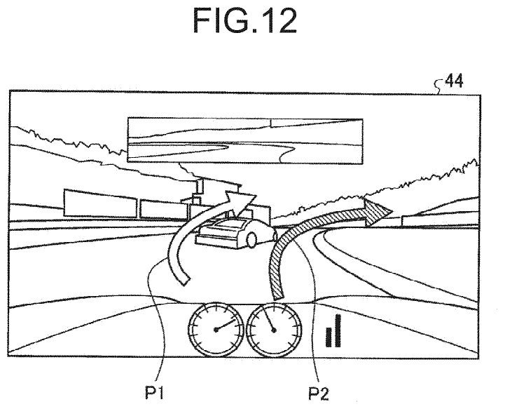

FIG. 12 is a schematic view illustrating an example of a display screen 44 including the advice information. FIG. 12 illustrates a case where the content 32 is the drive game 32A (see FIG. 2) as an example. For example, the control unit 24 of the terminal device 12 outputs the display screen 44, obtained by arranging a line P1 and a line P2 indicating the advice information on a game screen provided in the drive game 32A, to the UI unit 26.

The line P1 is an image illustrating the first action aa of the first user U1. The line P2 is an image illustrating the recommended action ab of the second user U2. The terminal device 12 may display the display screen 44 illustrating these line P1 and line P2 to output the information indicating the difference between the first action aa of the first user U1 and the recommended action ab of the second user U2.

Note that the display screen 44 may be generated on the information processing device 10B side or the terminal device 12 side similarly to the first embodiment.

### Information Processing Procedure According to Second Embodiment

Next, an example of an information processing procedure executed by the information processing device 10B will be described.

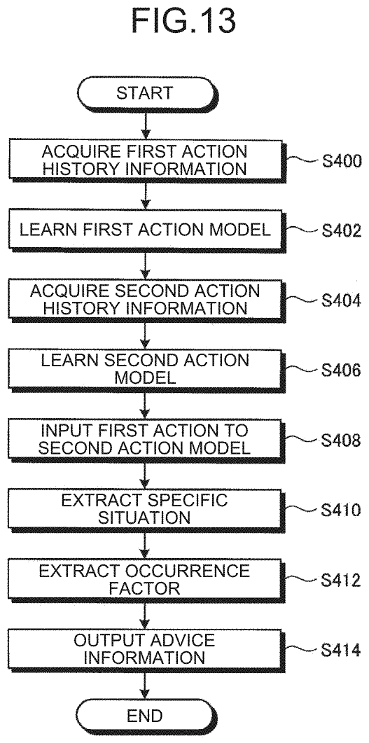

FIG. 13 is a flowchart illustrating an example of the information processing procedure executed by the information processing device 10B.

First, the first learning unit 18A acquires the first action history information 20A from the storage unit (Step S400). Next, the first learning unit 18A learns the first action model based on the first action history information 20A acquired in Step S400 (Step S402).

Next, the second learning unit 18B acquires the second action history information 20B from the storage unit (Step S404). Next, the second learning unit 18B learns the second action model based on the second action history information 20B acquired in Step S404 (Step S406).

Next, the extraction unit 19C inputs each of the situations s indicated in the first action history information 20A into the second action model learned in Step S406 to derive a recommended action ab corresponding to the situation s (Step S408).

Then, the extraction unit 19C extracts, for each of the situations s indicated in the first action history information 20A, a situation s in which the difference between the corresponding first action aa and the corresponding recommended action ab derived using the second action model in Step S408 is the second threshold or more as a specific situation (Step S410).

Next, the extraction unit 19C extracts an occurrence factor of the specific situation extracted in Step S410 based on the first action model learned in Step S402 and the specific situation extracted in Step S410 similarly to the extraction unit 18C of the first embodiment (Step S412).

Next, the output control unit 18D outputs advice information regarding the specific situation extracted in Step S410 and the occurrence factor extracted in Step S412 to the terminal device 12 (Step S414). Then, this routine is ended.

As described above, in the information processing device 10B of the present embodiment, the second learning unit 18B learns the second action model as the action model to derive the recommended action ab from the situation s based on the second action history information 20B. The extraction unit 19C extracts the situation s where the difference between the first action aa and the recommended action ab is the second threshold or more as the specific situation based on the first action history information 20A and the second action model.

In this manner, the information processing device 10B of the present embodiment extracts, as the specific situation, the situation s in which the difference between the first action aa corresponding to the situation s indicated in the first action history information 20A of the first user U1 and the recommended action ab corresponding to the situation s derived from the second action model is the second threshold or more.

For this reason, the recommended action ab of the second user U2 corresponding to each of the situations s indicated in the first action history information 20A can be derived even if the situation s indicated in the first action history information 20A and the situation s indicated in the second action history information 20B do not coincide at least partially.

Therefore, the information processing device 10B of the present embodiment can provide the advice information according to the action of the user U with high accuracy in addition to the effects of the above embodiment.

Further, the advice information indicates at least one of the content of the specific situation, the occurrence factor of the specific situation, the difference between the action a of the user U and the recommended action ab for the specific situation, and the method for avoiding the specific situation.

For this reason, the information processing device 10B of the present embodiment can provide appropriate advice information according to the action of the user U in addition to the above effects.

Note that the embodiments and modification of the present disclosure have been described above, but the processing according to each of the above-described embodiments and modification may be implemented in various different forms other than each of the above-described embodiments and modification. Further, the above-described embodiments and modification can be appropriately combined within a range that does not contradict processing contents.

Further, the effects described in the present specification are merely examples and are not restrictive of the disclosure herein, and other effects not described herein also can be achieved.

### Application Target of Extraction Device and Information Processing Device of Above Embodiments and Modification

Application targets of the information processing devices 10, 10A, and 10B according to the above-described embodiments and modification are not limited. For example, the present invention can be applied to a system using the game device 12A, a development tool kit for game developers, and various systems that provide advice information with respect an action of the user U in the real space.

When applied to the development tool kit for game developers, it is possible to improve the efficiency in development of a game of raising a character or an avatar operating in the game or artificial intelligence (AI) installed in the game, in addition to the effects of the above-described embodiment and modification.

(Hardware Configuration)

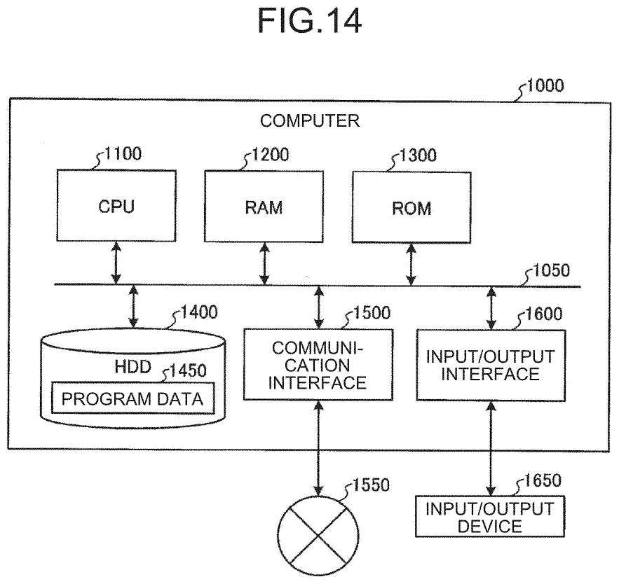

FIG. 14 illustrates a hardware configuration diagram illustrating an example of a computer 1000 that implements the functions of the information processing devices 10, 10A, and 10B and the terminal device 12 according to the above embodiments and modification.

The computer 1000 includes a CPU 1100, a RAM 1200, a read only memory (ROM) 1300, a hard disk drive (HDD) 1400, a communication interface 1500, and an input/output interface 1600. Each part of the computer 1000 is connected by a bus 1050.

The CPU 1100 is operated based on a program stored in the ROM 1300 or the HDD 1400, and controls each unit. For example, the CPU 1100 develops a program stored in the ROM 1300 or the HDD 1400 into the RAM 1200 and executes processes corresponding to various programs.

The ROM 1300 stores a boot program such as a basic input output system (BIOS) executed by the CPU 1100 when the computer 1000 starts up, a program depending on hardware of the computer 1000, and the like.

The HDD 1400 is a computer-readable recording medium that non-temporarily records a program executed by the CPU 1100, data used by the program, and the like. Specifically, the HDD 1400 is a recording medium that records a program and the like according to the present disclosure, which is an example of a program data 1450.

The communication interface 1500 is an interface for connecting the computer 1000 to an external network 1550 (for example, the Internet). For example, the CPU 1100 receives data from other devices or transmits data generated by the CPU 1100 to the other devices via the communication interface 1500.

The input/output interface 1600 is an interface for connecting between an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Further, the input/output interface 1600 may function as a media interface for reading a program or the like recorded on predetermined recording media. The media are, for example, optical recording media such as a digital versatile disc (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the information processing device 10 according to the first embodiment, the CPU 1100 of the computer 1000 implements the functions of the extraction unit 18C and the like by executing the information processing program loaded on the RAM 1200. Further, the HDD 1400 stores the information processing program according to the present disclosure or data in the storage unit 20 and the storage unit 21. Note that the CPU 1100 reads and executes the program data 1450 from the HDD 1400, but as another example, the CPU 1100 may acquire these programs from other devices via the external network 1550.

Note that the present technology can also have the following configurations.
(1)

An information processing device comprising:

an extraction unit that extracts a specific situation of a content whose situations change according to an action of a user based on an action model of the user; and

an output control unit that outputs advice information regarding the specific situation.
(2)

The information processing device according to (1), further comprising

a first learning unit that learns a first action model as the action model to derive a first action from the situation based on first action history information indicating a correspondence between the situation and the first action of a first user as the user, wherein

the extraction unit

extracts, as the specific situation, the situation in which an evaluation value of the situation, output from the content when the first action derived from the first action model is input as the action, is a first threshold or less.
(3)

The information processing device according to (2), wherein

the extraction unit further

extracts a correspondence between the situation and the first action during a period prior to an occurrence timing of the specific situation as an occurrence factor of the specific situation.
(4)

The information processing device according to (3), wherein

the extraction unit

extracts a correspondence between the situation and the first action as the occurrence factor, the situation having the evaluation value, output from the content at the occurrence timing, exceeding the first threshold when a correction action obtained by correcting the first action is input to the content as the action, among the situations during the period prior to the occurrence timing of the specific situation.
(5)

The information processing device according to (1), further comprising

a second learning unit that learns a second action model as the action model to derive a recommended action from the situation based on second action history information indicating a correspondence between the situation and the recommended action of a second user serving as the user, wherein

the extraction unit

extracts the situation in which a difference between the first action and the recommended action is a second threshold or more as the specific situation based on first action history information, which indicates a correspondence between the situation and a first action of a first user serving as the user, and the second action model.
(6)

The information processing device according to (1), further comprising:

a generation unit that generates third action history information, obtained by replacing a first action whose difference from a recommended action is a predetermined value or more among the first actions of first action history information with the recommended action

based on the first action history information indicating a correspondence between the situation and the first action of a first user serving as the user, and second action history information indicating a correspondence between the situation and the recommended action of a second user serving as the user; and

a third learning unit that learns third action model as the action model to derive a third action, which serves as the first action and the recommended action in the third action history information, from the situation based on the third action history information, wherein

the extraction unit

extracts, as the specific situation, the situation in which an evaluation value of the situation output from the content is a third threshold or more when the third action derived from the third action model is input as the action.
(7)

The information processing device according to any one of (1) to (6), wherein

the advice information

indicates at least one of a content of the specific situation, an occurrence factor of the specific situation, a difference between an action of the user and a recommended action for the specific situation, and a method for avoiding the specific situation.
(8)

An information processing method, by a computer, comprising:

extracting a specific situation of a content whose situation changes according to an action of a user based on an action model of the user; and

outputting advice information regarding the specific situation.

### REFERENCE SIGNS LIST

10, 10A, 10B INFORMATION PROCESSING DEVICE

17E GENERATION UNIT

17F THIRD LEARNING UNIT

18A FIRST LEARNING UNIT

18B SECOND LEARNING UNIT

18C, 19C EXTRACTION UNIT

18D OUTPUT CONTROL UNIT

1. An information processing device comprising:
an extraction unit that extracts a specific situation of a content whose situations change according to an action of a user based on an action model of the user; and
an output control unit that outputs advice information regarding the specific situation.

2. The information processing device according to claim 1, further comprising
a first learning unit that learns a first action model as the action model to derive a first action from the situation based on first action history information indicating a correspondence between the situation and the first action of a first user as the user, wherein
the extraction unit
extracts, as the specific situation, the situation in which an evaluation value of the situation, output from the content when the first action derived from the first action model is input as the action, is a first threshold or less.

3. The information processing device according to claim 2, wherein
the extraction unit further
extracts a correspondence between the situation and the first action during a period prior to an occurrence timing of the specific situation as an occurrence factor of the specific situation.

4. The information processing device according to claim 3, wherein
the extraction unit
extracts a correspondence between the situation and the first action as the occurrence factor, the situation having the evaluation value, output from the content at the occurrence timing, exceeding the first threshold when a correction action obtained by correcting the first action is input to the content as the action, among the situations during the period prior to the occurrence timing of the specific situation.

5. The information processing device according to claim 1, further comprising
a second learning unit that learns a second action model as the action model to derive a recommended action from the situation based on second action history information indicating a correspondence between the situation and the recommended action of a second user serving as the user, wherein
the extraction unit
extracts the situation in which a difference between the first action and the recommended action is a second threshold or more as the specific situation based on first action history information, which indicates a correspondence between the situation and a first action of a first user serving as the user, and the second action model.

6. The information processing device according to claim 1, further comprising:
a generation unit that generates third action history information, obtained by replacing a first action whose difference from a recommended action is a predetermined value or more among the first actions of first action history information with the recommended action
based on the first action history information indicating a correspondence between the situation and the first action of a first user serving as the user, and second action history information indicating a correspondence between the situation and the recommended action of a second user serving as the user; and
a third learning unit that learns third action model as the action model to derive a third action, which serves as the first action and the recommended action in the third action history information, from the situation based on the third action history information, wherein
the extraction unit
extracts, as the specific situation, the situation in which an evaluation value of the situation output from the content is a third threshold or more when the third action derived from the third action model is input as the action.

7. The information processing device according to claim 1, wherein
the advice information
indicates at least one of a content of the specific situation, an occurrence factor of the specific situation, a difference between an action of the user and a recommended action for the specific situation, and a method for avoiding the specific situation.

8. An information processing method, by a computer, comprising:
extracting a specific situation of a content whose situation changes according to an action of a user based on an action model of the user; and
outputting advice information regarding the specific situation.
